(19) United States
(12) Patent Application Publication
(10) Pub. No.: US 2009/0152916 A1
(43) Pub. Date: Jun. 18, 2009

(54) SEAT SUBPORTION ADJUSTABLE IN RELATIVE HEIGHT AND/OR ANGLE AND BACKREST ADJUSTABLE IN SHAPE

(76) Inventors: Fang Lin, Chicago, IL (US); Mohsen Makhsous, Chicago, IL (US); Ellis K. Nam, Chicago, IL (US); Sam Perlmutter, Chicago, IL (US)

Correspondence Address: CHERSKOV & FLAYNIK, THE CIVIC OPERA BUILDING, 20 NORTH WACKER DRIVE, SUITE 1447, CHICAGO, IL, 60606, US

(21) Appl. No.: 12/389,931

(22) Filed: Feb. 20, 2009

Related U.S. Application Data
(63) Continuation-in-part of application No. 11/969,744, filed on Jan. 4, 2008.
Application No. 11/969,744 is a division of application No. 10/856,612, filed on May 28, 2004, now Pat. No. 7,322,651.

(51) Int. Cl. A47C 7/00; A47C 3/00; G06F 17/00; A47C 7/46; A47C 31/00

(52) U.S. Cl. 297/217.3; 297/284.4

(57) ABSTRACT

A seat of an apparatus, in one example, comprises a front subportion and a rear subportion that is adjustable in height and/or angle relative to the front subportion. A backrest of the apparatus, in one example, is adjustable in shape. Based on a manipulation of adjustments, a subportion of the seat and the backrest are adjustable between: a first height and/or angle of the rear subportion of the seat and a first shape of the backrest; and a second height and/or angle of the rear subportion of the seat and a second shape of the backrest.

### CROSS REFERENCE TO RELATED APPLICATIONS

This application is a continuation-in-part of, and claims priority from, U.S. patent application Ser. No. 11/969,744 filed Jan. 4, 2008, presently pending, which is a divisional of U.S. patent application Ser. No. 10/856,612 filed May 28, 2004, now U.S. Pat. No. 7,322,651 issued Jan. 29, 2008.

### BACKGROUND OF THE INVENTION

1. Field of the Invention

The invention relates generally to seats and backrests and more particularly to adjustment of seats and backrests.

2. Background of the Invention

People who sit for prolonged periods and people who use wheelchairs are often affected by low back pain, poor blood circulation of the lower body, and pressure sores. Low back pain associated with extended sitting is likely caused by poor sitting posture which flattens the natural curvature of the spine and increases the stress on back muscles.

Sitting-related pressure-sores are primarily caused by concentrated, prolonged pressure on a posterior area of a hip bone, such as the ischial tuberosities or coccyx. Adjustment of the seating position of the user to redistribute contact pressure promotes increased in blood circulation, promotes healing of established pressure sores, and reduces the risk of future pressure sores.

Users are advised that during extended sitting they should occasionally perform “push-ups” in their chair to adjust their seating position and reduce contact pressure that may otherwise cause pressure sores. Users of wheelchairs may have a disability or lack strength that prevents them from performing the push-up or adjusting their seating position themselves. They also may be unable to notice when poor circulation and sustained elevated pressures give rise to pressure sores.

Thus, a need exists for a seat and backrest that promote an increase in blood circulation. The seat and backrest should promote a reduction in contact pressure build-up for a user. Also, the seat and backrest should promote a restoration of the natural curvature of the spine for the user and promote a reduction in stress of the back muscles. Finally, the seat and backrest should promote comfort for the user over extended periods of sitting by selectively removing and applying pressure surfaces to a user.

### SUMMARY OF INVENTION

An object of the present invention is to provide an adjustable seat and backrest combination. A feature of the invention is that the seat comprises a front subportion and rear subportion and each subportion may be adjusted during apparatus use. An advantage of the invention is that the apparatus position-changes result in changes to amounts of pressure experienced by areas of the user's body.

Another object of the present invention is to provide an apparatus wherein changes to the seat subportion position and the backrest shape are accomplished without use of powered equipment. A feature of the invention is that some embodiments rely on manually-activated adjustment components. An advantage of the present invention is that it can be used in environments where power is not readily available, such as during travel or while the user is in facilities where power is designated for a particular use. A further benefit of the invention is that the apparatus can be fully functional without having to accommodate the added weight of batteries.

Yet another object of the invention is to provide for significant shifts to the user's position through simultaneous changes to the backrest shape and the position of a seat subportion. A feature of the invention is that in some embodiments a single manual-adjustment means modifies both the seat subportion position and the backrest shape. An advantage of the present invention is that significant shifts in user's pressure points are effectuated by operation of a single adjustment means.

Still another object of the invention is to provide a seat wherein the relative positions of a front subportion and a rear subportion can be changed. A feature of the present invention is that the position of either the front subportion can be changed and/or the position of the rear subportion can be changed. Another feature is an audible signature to identify intermediate and final positions of various adjustable components. An advantage of the present invention is that changes to the user's pressure point distribution can be accomplished by altering the relative position of either the front subportion or the rear subportion depending on the type of shift of pressure point distribution desired.

Another object of the present invention is to provide a seat wherein the amount of user seat subportion support is highly adjustable. A feature of the present invention is that the rear seat subportion defines a plurality of discrete segments each independently adjustable. An advantage of the present invention is that the amount of support provided to the user can be closely controlled through selecting the position of each rear seat subportion segment.

Yet another object of the present invention is to provide an adjustable seat wherein the seat communicates with a telescoping adjustment means. A feature of the present invention is that telescoping pistons used to adjust the position of the rear seat subportion can be mounted in either the push or pull orientation. An advantage of the present invention is that the position of the adjustment means can be selected so as to retrofit pre-existing seat assemblies.

The invention in one implementation encompasses an apparatus comprising a seat and a backrest. The seat comprises a front subportion and a rear subportion that is adjustable in height and/or angle relative to the front subportion. The backrest is adjustable in shape. Based on a user contact pressure against one or more portions of the seat and/or one or more portions of the backrest, the rear subportion of the seat and the backrest are adjustable between: a first height and/or angle of the rear subportion of the seat and a first shape of the backrest; and a second height and/or angle of the rear subportion of the seat and a second shape of the backrest.

Another implementation of the invention encompasses a method. A backrest is adjusted between a first shape and a second shape based on a user contact pressure against one or more portions of the backrest and/or one or more portions of a seat. A rear subportion of the seat is adjusted between a first height and/or angle and a second height and/or angle relative to a front subportion of the seat based on the user contact pressure against the one or more portions of the backrest and/or the one or more portions of the seat.

A further implementation of the invention encompasses an article. The article comprises one or more computer-readable signal-bearing media. The article includes means in the one or more media for adjusting a backrest between a first shape and a second shape based on a user contact pressure against one or more portions of the backrest and/or one or more portions of a seat. The article includes means in the one or more media for adjusting a rear subportion of the seat between a first height and/or angle and a second height and/or angle relative to a front subportion of the seat based on the user contact pressure against the one or more portions of the backrest and/or the one or more portions of the seat.

In a further implementation, the invention encompasses an apparatus. The apparatus comprises a seat that in turn comprises a front subportion and a rear subportion wherein the rear subportion is supported by an one or more adjustable supports; a means for adjusting a rear subportion; a backrest; a lumbar contact substrate; and a means for adjusting position of the lumbar contact substrate; wherein, manipulation of the rear subportion adjustment means changes the position of the rear subportion of the seat from a first height and/or angle of the rear subportion of the seat to a second height and/or angle of the rear subportion of the seat; and wherein, manipulation of the backrest shape adjustment means changes the shape of the backrest from a first shape of the backrest to a second shape of the backrest, and manipulation of the lumbar contact substrate adjustment means changes the position of the lumbar contact substrate.

In still another implementation, the apparatus comprising the invention is a seat that comprises a front subportion and a rear subportion that is supported by an one or more adjustable supports; a lumbar contact substrate; a backrest; an adjustment mechanism in communication with the rear seat subportion and the lumbar contact substrate; and wherein, manipulation of the adjustment mechanism changes the position of the rear seat subportion from a first position to a second position and the lumbar contact substrate changes shape from a first shape to a second shape.

### BRIEF DESCRIPTION OF DRAWINGS

The invention together with the above and other objects and advantages will be best understood from the following detailed description of the preferred embodiment of the invention shown in the accompanying drawings, wherein:

FIG. 1 is a representation of one implementation of an apparatus that comprises a seat, a backrest, a leg support, and a control component.

FIG. 2 is a representation of another implementation of the apparatus of FIG. 1, illustrating a rear subportion of the seat in an angled position.

FIG. 3 is a representation of yet another implementation of the apparatus of FIG. 1, illustrating the rear subportion of the seat in a lowered position.

FIG. 4 is a representation of a further implementation of the apparatus of FIG. 1 where the rear subportion of the seat comprises an air bladder, illustrating a state in which the air bladder is inflated.

FIG. 5 is a representation of the implementation of the apparatus of FIG. 4, further illustrating a state in which the air bladder is deflated.

FIG. 6 is a top representation of the backrest of FIG. 1 where the backrest comprises one or more side bolsters with one or more air bladders, illustrating the air bladders in an inflated state.

FIG. 7 is a top representation of the implementation of the apparatus of FIG. 6, illustrating the air bladders of the backrest in a deflated state.

FIG. 8 is a representation of a still further implementation of the apparatus of FIG. 1, illustrating suspension components of the backrest.

FIG. 9 is a representation of another implementation of the apparatus of FIG. 1 where the rear subportion of the seat comprises an air bladder, illustrating a state in which the air bladder is inflated.

FIG. 10 is a representation of the implementation of the apparatus of FIG. 9, further illustrating a state in which the air bladder is deflated.

FIG. 11A is an elevated view of an alternative implementation of the apparatus that comprises a seat featuring a rear subportion, a front subportion, a mechanism for adjusting the rear subportion of the seat, and a backrest, in accordance with features of the present invention.

FIG. 11B is a perspective view of a seat featuring a rear subportion and a front subportion.

FIG. 11C is a view of FIG. 11B taken along lines c-c depicting a telescopic means for adjusting the front subportion.

FIG. 11D is a perspective view of a seat featuring a rear subportion, and a front subportion wherein the front subportion is in an elevated position.

FIG. 11E is a view of FIG. 11D, taken along lines e-e in accordance with features of the present invention.

FIG. 12A is an elevated view of yet another embodiment of the apparatus, showing a seat featuring a rear subportion, a front subportion, a mechanism for adjusting the rear subportion of the seat, and a backrest, further illustrating the rear subportion of the seat in a tilted position, in accordance with features of the present invention.

FIG. 12B is an elevated view of yet another embodiment of the apparatus, showing a seat featuring a rear subportion, a front subportion, a mechanism for adjusting the rear subportion of the seat, and a backrest, further illustrating the back portion of the seat in a horizontal position.

FIG. 13A is a perspective view of an implementation of the apparatus, showing a seat featuring a rear subportion, a front subportion, a mechanism for adjusting the angle of the rear subportion, and a backrest.

FIG. 13B is an elevated view of an implementation of the apparatus showing a backrest and a seat featuring a rear subportion and a front subportion wherein the rear subportion slidably communicates with the backrest and is in a tilted position, in accordance with features of the present invention.

FIG. 13C is a perspective view of an implementation of the apparatus, showing a seat featuring a rear subportion, a front subportion, a mechanism for adjusting the angle of the rear subportion, and a backrest.

FIG. 13D is an elevated view of an implementation of the apparatus showing a backrest and a seat featuring a rear subportion and a front subportion wherein the rear portion is mounted on the front subportion and in an opened position.

FIG. 14A is a perspective view of an embodiment of the apparatus seat showing a front subportion and a rear subportion wherein the rear subportion is further subdivided into segments and all the segments are in an upright user-bearing position.

FIG. 14B is a perspective view of an implementation of the apparatus seat showing a front subportion and a rear portion wherein the rear subportion is further subdivided into segments and a plurality of the segments are deployed downwardly.

FIG. 14C is an elevated view of an implementation of the apparatus shown in FIG. 14A, further depicting, a telescoping support, with all segments of the rear subportion of the seat fully supported by the telescoping support, in accordance with features of the present invention.

FIG. 14D is an elevated view of an implementation of the apparatus seat showing a front subportion, a telescoping support, and a rear subportion wherein the rear subportion is further subdivided into segments with some segments partially supported by the telescoping support, and other segments free hanging, in accordance with features of the present invention.

FIG. 14E is an elevated view of an implementation of the apparatus seat showing a front subportion, a telescoping support, and a rear subportion wherein the rear subportion is further subdivided into segments and the telescoping support is fully retracted.

FIG. 15A is an elevated view of yet another implementation of the apparatus, showing a seat featuring a rear subportion, a front subportion, a mechanism for adjusting the rear subportion of the seat, and a backrest further illustrating a lumbar support region of the backrest in an extended position.

FIG. 15B is an elevated view of yet another implementation of the apparatus, showing a seat featuring a rear subportion, a front subportion, a mechanism for adjusting the rear subportion of the seat, and a backrest further illustrating a lumbar support region of the backrest in a flattened position.

FIG. 16A is a perspective view of yet another embodiment of the apparatus, showing a backrest, and a seat featuring a front subportion and a rear subportion wherein both seat portions are substantially coplanar and component panels of the backrest are essentially vertically coplanar, in accordance with features of the present invention.

FIG. 16B is another view of the embodiment depicted in FIG. 16A, showing a backrest wherein a lumbar support is shown extending inwardly from the backrest toward a user-occupied region, and a seat featuring a front subportion and a rear seat portion not coplanar with the front subportion.

FIG. 16C is a view of FIG. 16A taken along line c-c.

FIG. 16D is a view of FIG. 16B taken along line d-d.

FIG. 16E is a view of FIG. 16A taken along line e-e;

FIG. 16F is a view of FIG. 16B taken along line f-f;

FIG. 16G is a cross-section view of a backrest of an embodiment of the apparatus in one configuration, in accordance with features of the present invention;

FIG. 16H is a cross-section view of a backrest of an embodiment of the apparatus in another configuration, in accordance with features of the present invention; and

FIG. 17 is an elevated view of a seat depicting a rear seat subportion pivoting through a horizontal plane about a center point, in accordance with features of the invention.

### DETAILED DESCRIPTION OF THE INVENTION

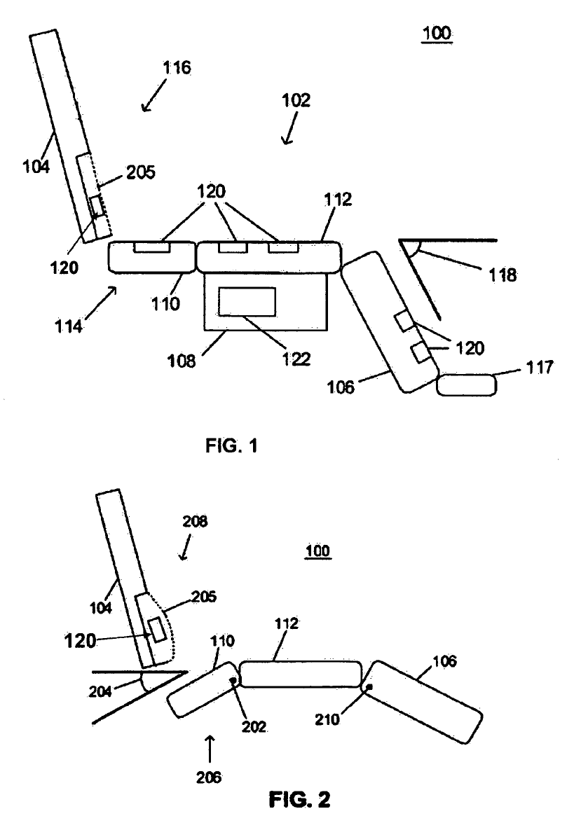

Turning to FIG. 1, an apparatus 100 in one example comprises one or more of a seat 102, a backrest 104, a leg support 106, and/or one or more control components 108. The seat 102 comprises a rear subportion 110 and a front subportion 112. The rear subportion 110 provides ischial support to a user (not shown). For example, the rear subportion 110 provides support to a posterior area of the user's buttocks. The rear subportion 110 in one example is adjustable in angle relative to the front subportion 112. For example, the rear subportion 110 can be tilted upward and/or downward about an axis 202 (FIG. 2) across an angle 204 (FIG. 2). The rear subportion 110 in another example is adjustable in height relative to the front subportion 112. For example, the rear subportion 110 can be raised or lowered along a direction 302 (FIG. 3). In a further example, the rear subportion 110 both raises and lowers along the direction 302 and tilts about the axis 202. The rear subportion 110 in one example comprises one or more input components 120, as described herein. The seat 102, backrest 104, and leg support 106 in one example comprise a portion of a chair, wheelchair, and/or car seat.

The front subportion 112 provides thigh support to the user. The front subportion 112 in one example is adjustable across the angle 204 and/or an angle 118 relative to the rear subportion 110 and/or the leg support 106. The front subportion 112 in one example comprises one or more input components 120, as described herein.

The leg support 106 in one example comprises a foot support 117. The leg support 106 and/or the foot support 117 provide support for the legs and/or feet of the user. The leg support 106 in one example is adjustable in height and/or angle relative to the seat 102. The leg support 106 in one example pivots about an axis 210 to change the knee angle 118 of the user, for example, between approximately ninety degrees and twenty degrees. A change in the knee angle 118 of the user promotes a change in distribution of weight of the user against the seat 102. For example, reducing the knee angle 118 (i.e. raising the feet of the user) reduces a peak contact pressure of the user against the seat 102, as will be appreciated by those skilled in the art.

One or more of the seat 102, the backrest 104, and/or the leg support 106 in one example comprise one or more input components 120, for example, contact pressure sensors, air pressure sensors, temperature sensors, accelerometers, and/or clocks inputs. In one example, the seat 102, the backrest 104, and the leg support 106 comprise one or more contact pressure sensors. The contact pressure sensors provide a contact pressure against the seat 102 and/or backrest 104, for example, a contact pressure due to the user. Contact pressure sensors may also be located on a surface of an air bladder 205 (FIG. 2). In another example, the seat 102 and/or the backrest 104 comprise air pressure sensors for the air bladder 205. For example, the air pressure sensors measure the pressure within the air bladder 205. In yet another example, the seat 102 and the backrest 104 comprise one or more temperature sensors. The temperature sensors measure a dermal temperature of the user. The seat 102 and/or the backrest 104 in one example comprise accelerometers for measuring a vibration of the seat 102 and/or the backrest 104.

The control component 108 in one example is communicatively coupled with one or more of the seat 102, the backrest 104, and/or the leg support 106. For example, the control component 108 signals one or more of the seat 102 and/or the backrest 104 to cause an adjustment of the seat 102 and/or the backrest 104. The control component 108 in one example is communicatively coupled with one or more of the input components 120. In one example, the control component 108 causes an adjustment of one or more of the seat 102, the backrest 104, and/or the leg support 106 based on a user contact pressure against the seat 102, the backrest 104, and/or the leg support 106. For example, the control component 108 causes the adjustment to change an amount of ischial support provided to the user and/or change a distribution of contact pressure of the user, as described herein. In a further example, the control component 108 causes the adjustment of the seat 102, the backrest 104, and/or the leg support 106 based on one or more inputs from the input components 120. Exemplary inputs comprise the contact pressure of the user against one or more portions of the seat 102, the backrest 104, and/or the leg support 106, the dermal temperature of the user, the vibration of the seat 102 and/or the backrest 104, and a clock input. The control component 108 in one example comprises an instance of a recordable data storage medium 122, as described herein. The control component 108 in one example comprises a user interface screen for receiving manual inputs for adjustments from the user to position the seat 102, the backrest 104, and/or the leg support 106.

To change the amount of ischial support provided to the user, the control component 108 in one example adjusts the seat 102, the backrest 104, and/or the leg support 106. For example, the control component 108 adjusts the rear subportion 110 and/or the front subportion 112 to cause a change in a distribution of contact pressure between the user and the seat 102 and/or the backrest 104. The control component 108 changes the distribution of contact pressure to promote a reduction in pressure sores to the user, as will be appreciated by those skilled in the art.

Turning to FIG. 2, the rear subportion 110 in one example pivots about the axis 202 to adjust the angle 204 of the rear subportion 110 relative to the front subportion 112. The rear subportion 110 in one example comprises a hinge about the axis 202. The rear subportion 110 in one example comprises one or more of a lever arm, an electric motor, worm gear, jack, and/or a hydraulic system that cause the rear subportion 110 to pivot about the axis 202. The rear subportion 110 pivots about the axis 202, for example, between a position 114 and a position 206. In one example, the position 114 comprises a height of the rear subportion 110 along the direction 302 that is substantially the same as a height of the front subportion 112 along the direction 302. In a further example, the position 114 comprises an angle 204 of the rear subportion 110 that is substantially the same as an angle 204 of the front subportion 112. In the position 206, the angle 204 of the rear subportion 110 is approximately between ten to seventy degrees. The position 206 provides less ischial support to the user than the position 114, as will be appreciated by those skilled in the art.

Turning to FIG. 3, the rear subportion 110 in one example raises and/or lowers the height of the rear subportion 110 along the direction 302 from the position 114 to a position 304. For example, the rear subportion 110 lowers approximately three to ten centimeters along the direction 302. The rear subportion 110 in one example comprises one or more of a lever arm, an electric motor, worm gear, jack and/or a hydraulic system that cause the rear subportion 110 to raise and/or lower along the direction 302. The position 304 provides less ischial support to the user than the position 114, as will be appreciated by those skilled in the art.

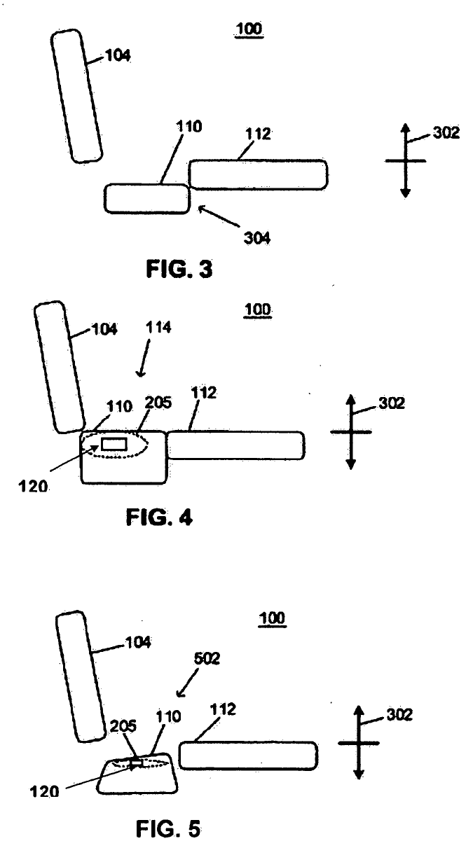

Turning to FIGS. 4-5, the rear subportion 110 in one example comprises one or more air bladders 205. The control component 108 in one example signals an air compressor to inflate and/or deflate the air bladders 205. The air bladder 205 of FIG. 4 is inflated such that the rear subportion 110 is in the position 114. The air bladder 205 of FIG. 5 is deflated such that the rear subportion 110 is in a position 502. The position 502 in one example comprises a height of the rear subportion 110 along the direction 302 approximately three to ten centimeters lower than the height of the front subportion 112 along the direction 302. The position 502 provides less ischial support to the user than the position 114, as will be appreciated by those skilled in the art.

Referring to FIGS. 1-2, the backrest 104 is adjustable in shape. In one example, the backrest 104 comprises a shape 116 that provides support for the user sitting on the seat 102 with the backrest 104 in an upright position. In another example, the backrest 104 comprises a shape 208 that provides increased lumbar support and stabilization of the pelvis for the user. For example, the backrest 104 expands to the shape 208 that is larger than the shape 116 to provide the increased lumbar support and stabilization of the pelvis. The backrest 104 in one example comprises one or more air bladders 205. For example, the air bladder 205 inflates to expand the backrest 104 from the shape 116 to the shape 208. The air bladder 205 deflates to change the backrest 104 from the shape 208 to the shape 116. In another example, the backrest 104 comprises one or more of a lever arm, an electric motor, worm gear, jack, and/or a hydraulic system that cause the backrest 104 to expand and/or contract between the shapes 116 and 208.

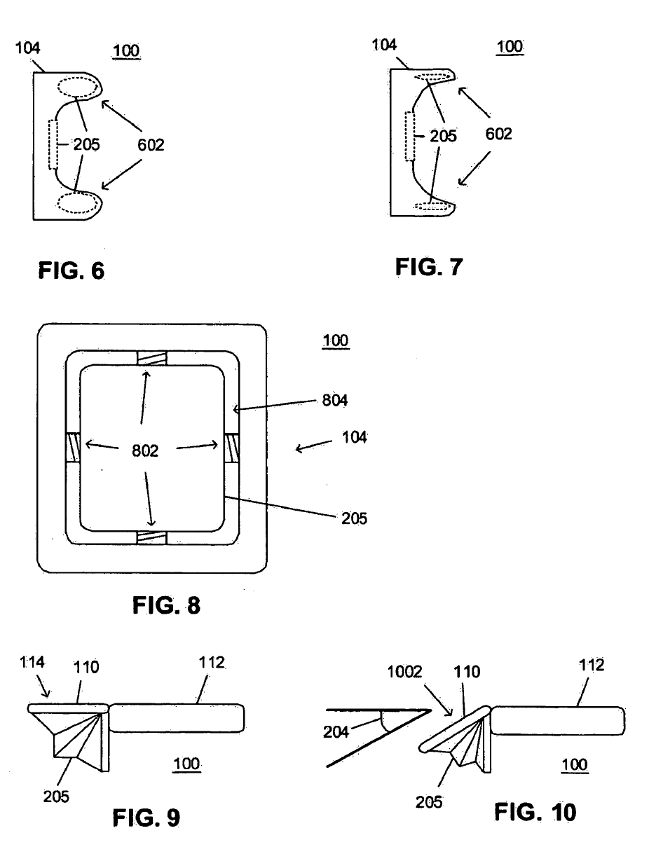

Turning to FIGS. 6-7, the backrest 104 in one example comprises one or more side bolsters 602. The side bolsters 602 provide lateral and/or trunk support to the user. In a further example, the seat 102 and/or the leg support 106 comprise side bolsters 602 analogous to the backrest 104. The side bolsters 602 in one example comprise one or more air bladders 205. For example, the air bladders 205 inflate to provide additional lateral support to the user (FIG. 6), or deflate to reduce and/or remove lateral support (FIG. 7), as will be appreciated by those skilled in the art.

Turning to FIG. 8, the backrest 104 in one example comprises one or more suspension components 802. The seat 102 and/or the leg support 106 in one example comprise suspension components 802 analogous to the backrest 104. Exemplary suspension components 802 comprise springs or elastic, compressible, and/or flexible material. The suspension components 802 in one example suspend one or more portions of the backrest 104, for example, the air bladder 205, within an aperture 804 of the backrest 104 to allow the air bladder 205 of the backrest 104 to oscillate in one or more directions. For example, the suspension components 802 allow the air bladder 205 to move with the spine of the user when the seat 102 and/or backrest 104 are jolted by an external force, such as a car seat when moving down a bumpy road or a wheelchair over a cracked sidewalk. Oscillation of the air bladder 205 increases mobility of the user's spine. For example, the suspension components 802 reduce whole-body vibration of the user, as will be appreciated by those skilled in the art.

Turning to FIGS. 9-10, another implementation of the rear subportion 110 in one example comprises one or more air bladders 205. The control component 108 in one example signals an air compressor to inflate and/or deflate the air bladders 205. The air bladder 205 of FIG. 9 is inflated such that the rear subportion 110 is in the position 114. The air bladder 205 of FIG. 10 is deflated such that the rear subportion 110 is in a position 1002. In the position 1002, the angle 204 of the rear subportion 110 is approximately between ten to seventy degrees. The position 1002 provides less ischial support to the user than the position 114, as will be appreciated by those skilled in the art.

The seat 102, the backrest 104, and/or the leg support 106 in one example comprise viscoelastic foam. The foam comprises a soft upper layer on top of a firm lower layer to promote a damping of vibration of the user. The seat 102, the backrest 104, and/or the leg support 106 in one example comprise a fabric cover that promotes a reduction in shear forces between the user and the fabric cover, such as Rubatex® neoprene.

An illustrative description of exemplary operation of the apparatus 100 is presented, for explanatory purposes. Referring to FIG. 1, the rear subportion 110 is in the position 114. The backrest 104 is in the first shape 116 to provide support to the user. The position 114 and the first shape 116 comprise a first configuration. The user sits on the seat 102 and against the backrest 104.

Once the user is seated, the control component 108 in one example receives inputs from the input components 120 and causes one or more adjustments to one or more of the seat 102, the backrest 104, and/or the leg support 106 based on the inputs. The control component 108 in one example causes the adjustments to achieve a comfortable configuration and/or seating position for the user. In one example, the configuration promotes an even distribution of a contact pressure of the user against the seat 102 and the backrest 104. In another example, the configuration promotes a reduction in a peak contact pressure of the user against the seat 102 and the backrest 104. In yet another example, the configuration promotes a pre-determined ratio of contact pressures of the user.

The control component 108 adjusts one or more of the seat 102, the backrest 104, and/or the leg support 106 to a second configuration. The second configuration in one example comprises one or more of the positions 206, 304, 502, and/or 1002 of the rear subportion 110 and the shape 208 of the backrest 104. In a further example, the front subportion 112 tilts upward approximately zero to five degrees in the second configuration. The second configuration promotes a reduction in contact pressure of the ischial region of the user relative to the first configuration, as will be appreciated by those skilled in the art.

The control component 108 makes a determination of when to adjust between the first configuration and the second configuration. The control component 108 makes the determination based on one or more of the dermal temperature of the user against the seat 102 and/or backrest 104, the contact pressure of the user against the seat 102 and/or backrest 104, an end of a pre-determined time interval, acceleration of the seat 102 and/or backrest 104, and/or an input from the user.

In one example, the control component 108 employs the input components 120 to monitor the dermal temperature of the user. The input components 120 measure one or more of a peak dermal temperature and/or an average dermal temperature of the user. After a period of time sitting against the seat 102 and/or backrest 104, the dermal temperature of the user increases. Once the dermal temperature of the user reaches a pre-determined level, the control component 108 adjusts the seat 102 and/or the backrest 104 between the first and second configuration, as will be appreciated by those skilled in the art.

In another example, the control component 108 employs the input components 120 to monitor the contact pressure of the user. The input components 120 measure one or more of a peak pressure and/or an average pressure of the user. After a period of time sitting against the seat 102 and/or backrest 104, the user may become restless and fidget, causing changes in the contact pressure on the seat 102 and/or the backrest 104. The control component 108 monitors changes in pressure and adjusts the seat 102 and/or the backrest 104 between the first and second configuration when the user fidgets. For example, if the user makes several adjustments in seating position in a short time period, indicating discomfort, the control component 108 adjusts between the first and second configuration, as will be appreciated by those skilled in the art. In yet another example, the control component 108 employ the input components 120 to determine an end of a pre-determined time interval. For example, the control component 108 employs a clock input to adjust between the first and second configuration every T minutes, where T is between five and twenty minutes. In a further example, the control component 108 employs one or more manual inputs from the user to adjust between the first and second configurations. For example, the user presses a button or switch (not shown) to cause the adjustment between the first and second configurations. The user may also adjust individual components of the seat 102, the backrest 104, and/or the leg support 106 through employment of the button or switch.

The control component 108 in one example adjusts the seat 102, the backrest 104, and/or the leg support 106 in a pre-determined sequence. In one example for an adjustment from the first configuration to the second configuration, the control component 108 first adjusts the backrest from the shape 116 to the shape 208. The control component 108 then adjusts the rear subportion 110 from the position 114 to one or more of the positions 206, 304, 502, and/or 1002. In another example for an adjustment from the second configuration to the first configuration, the control component 108 first adjusts the rear subportion 110 from one or more of the positions 206, 304, 502, and/or 1002 to the position 114. The control component 108 then adjusts the backrest 104 from the shape 208 to the shape 116.

Adjustments of the seat 102, the backrest 104, and/or the leg support 106 in one example occur over a pre-determined time interval. For example, the control component 108 gradually adjusts the backrest 104 from the shape 116 to the shape 208 over a time interval of ten seconds. The control component 108 in one example causes adjustments of the seat 102, the backrest 104, and/or the leg support 106 concurrently. For example, the control component 108 starts an adjustment of the backrest 104 and, before completion of the adjustment of the backrest 104, starts an adjustment of the leg support 106, as will be appreciated by those skilled in the art.

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art. The apparatus 100 in one example comprises any (e.g., horizontal, oblique, or vertical) orientation, with the description and figures herein illustrating one exemplary orientation of the apparatus 100, for explanatory purposes.

The apparatus 100 in one example employs one or more computer-readable signal-bearing media. The computer-readable signal-bearing media store software, firmware and/or assembly language for performing one or more portions of one or more embodiments of the invention. An exemplary computer-readable signal-bearing medium for the apparatus 100 comprises the recordable data storage medium 122 of the control component 108. The computer-readable signal-bearing medium for the apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory. In another example, the computer-readable signal-bearing medium comprises a modulated carrier signal transmitted over a network comprising or coupled with the apparatus 100, for instance, one or more of a telephone network, a direct connection via serial or parallel cable, a local area network (“LAN”), a wide area network (“WAN”), the Internet, and a wireless network.

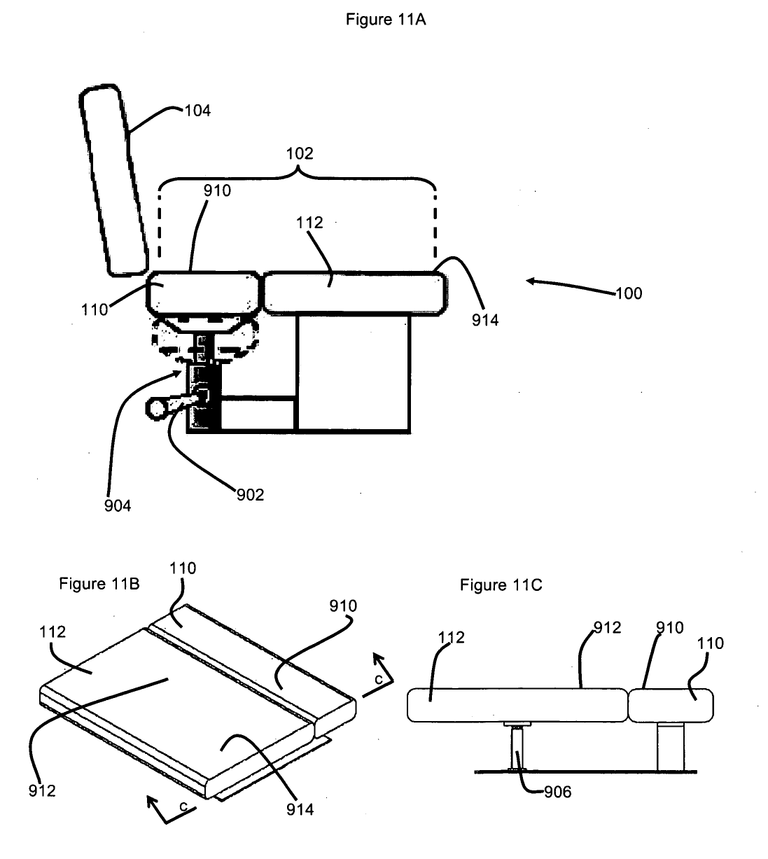

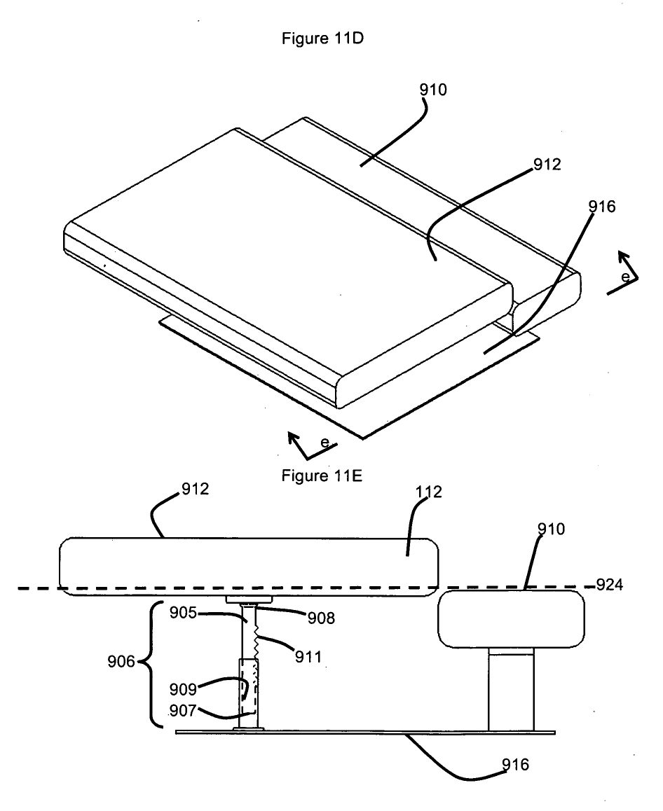

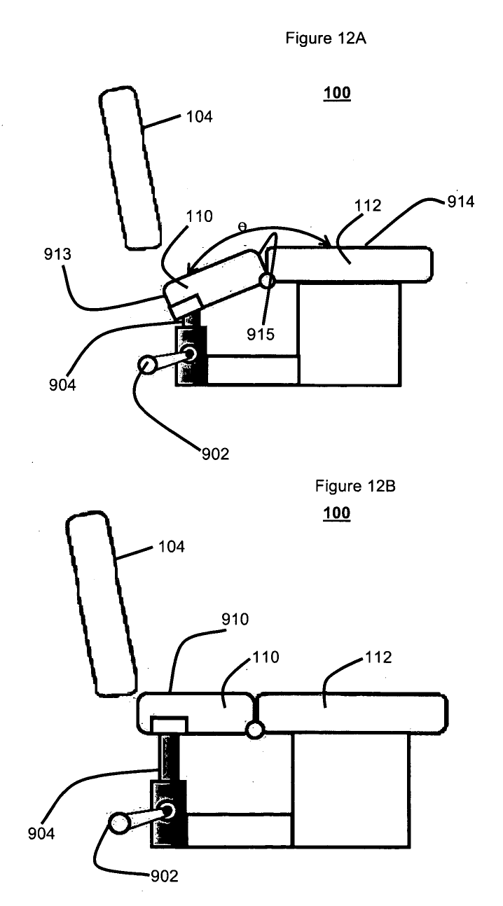

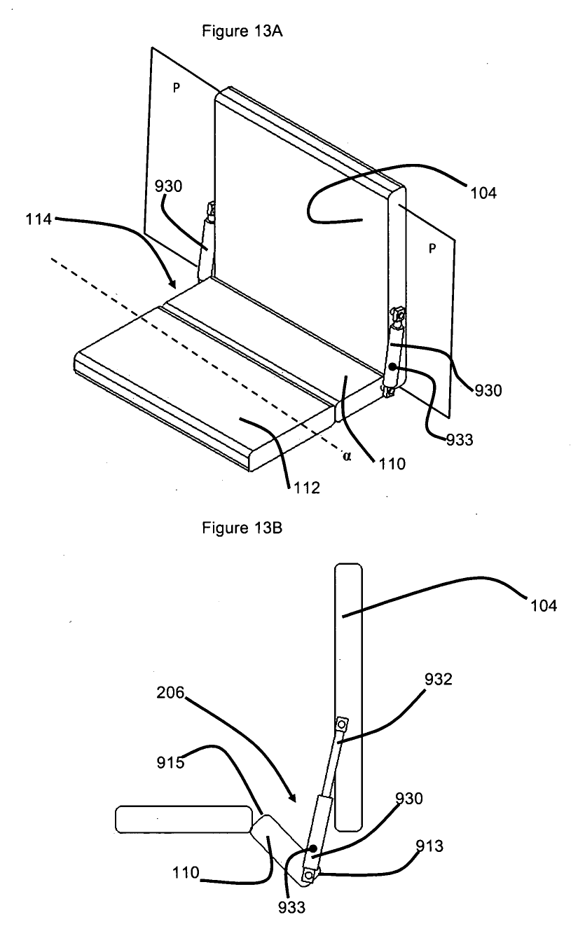

Alternative embodiments of the invention, as shown in FIGS. 11-16F, facilitate adjustment of various sections of the apparatus without the use of electro-mechanical components. Elimination of these components allows use of the apparatus in circumstances where the provision of a power source within the apparatus would be challenging.

As shown in FIGS. 11 and 12, an embodiment 100 comprises a seat 102, a backrest 104, a rear seat subportion vertical position movement means 904, and an adjustment means 902. The seat 102 comprises a rear subportion 110 with a user contact surface 910 and a front subportion 112. The two subportions form a user-bearing surface 914. The rear subportion 110 provides ischial support to a user.

As depicted in FIG. 11A, the rear subportion 110 is positioned to be substantially horizontal and coplanar with the front subportion 112. Alternatively, the rear subportion 110 comprises means 904 to allow the rear subportion 110 to be positioned horizontal yet not coplanar with the front subportion 112, as depicted in phantom in FIG. 11A.

As depicted in FIG. 12A, in one embodiment of the invention, the position of the rear subportion 110 varies along a range of positions, from substantially horizontal (and therefore co-planar with the front subportion 112) to sloping downward rearwardly so as to slope away from the front subportion. (This slope defines an angle Θ greater than 180 degrees relative to the user-contact surface of the front subportion.) In the later (sloped, as depicted in FIG. 12A) configuration, the rear seat portion does not extend upwardly through the plane formed by the front seat portion. Rather, substantially all portions of the user contact surface 910 of the rear seat portion is substantially non-coplanar with the user-contact surface 914 so as to be lower than the seat surface 914 of the front subportion 112.

The orientation of the rear subportion is positioned through operation of adjustment means 902. In one embodiment, the adjustment means 902 comprises a crank, wherein the crank transfers circular motion applied to it to a driving wheel. This driving wheel, in turn, adjusts the vertical position of a seat subportion.

Presented in FIG. 11B is a perspective view of the split-seat assembly without the backrest. As shown in FIG. 11B, the user bearing seat surface 914 comprises two subportions; a rear seat user support surface 910 and a front seat user support surface 912. FIGS. 11B and 11C show the front seat user-support surface co-planar to the rear seat user-support surface. The relative position of each subportion is adjustable through the operation of a mechanism, 906.

FIG. 11C shows a front seat subportion vertical position movement means 906 capable of adjusting the position of the front seat subportion surface 912 relative to the rear seat subportion surface 910. In the embodiment shown in FIG. 11C, the movement means 906 facilitates vertical movement of the front seat subportion 112 and is similar to the rear seat portion adjustment means 904, depicted in FIG. 11E, comprising a rod 905 adapted to be received by a sleeve 909, the rod 905 defining a rack 911 positioned along a longitudinally-extending region of the rod. The rack in turn engages with a circular gear or pinion actuated manually so as to couple vertical movement of the rod 905 within the sleeve 909. A proximal end 908 of the rod 905 is affixed to the underside of the support substrate. Alternatively, a hydraulic apparatus can be employed.

In this embodiment, the rear seat subportion surface 910 remains in a fixed vertical position. However, the rear seat subportion depicted in FIG. 11A also is adaptable to the embodiment depicted in FIG. 11C so that the front and rear subportions are enabled to move in the same device. The adjustment of the vertical position of the front subportion 112 of the seat facilitates a shift in the user's pressure points in a different manner than moving the position of the rear seat subportion surface 910. Specifically, by moving the front seat subportion 112 to a higher position, the user experiences a shift of the amount of weight carried by the ischial region away from the ischial region to thighs because the weight of the upper body of the user is then largely spread to the thighs. Additionally, moving the front seat subportion 112 can be integrated to the seat height adjustment mechanism that already implemented to the chair.

FIG. 11D depicts another perspective view of the apparatus seat assembly showing the front seat subportion user contact surface 912 in a higher position than the rear seat subportion user contact surface 910. As depicted in FIG. 11E, which is a view of FIG. 11D taken along line e-e, the front seat subportion vertical position is adjusted from an initial position (not shown) wherein a depending (i.e. distal) end 907 of the rod 905 rests against a support 916 for the front seat subportion. The support 916 defines a horizontally-disposed plane or surface. The surface may or may not extend beyond the periphery of the seat subportion 112 of the invented device. Other support structures, such as columns or other shapes, are considered. FIG. 11E is a side elevation view of the apparatus seat assembly. As detailed in FIG. 11E, the vertical position of the seat front subportion 112 is adjusted by operation of the front seat subportion vertical position movement means 906. In one position, the front seat subportion user contact surface 912 is in a higher vertical position than the rear seat subportion user contact surface 910. The initial co-planar level 924 of the rear seat subportion and the front seat subportion is also depicted via dotted line.

Turning now to FIG. 12A, shown therein is an apparatus 100 comprising a backrest 104 and a seat further comprising a front subportion 112 and a rear subportion 110 in proximity to the front subportion. As shown in this figure, upon activation of the adjustment means 904, a back edge (i.e. a distal end) 913 of the rear subportion 110 drops to a lowered position. While a front edge (i.e. proximal edge) 915 of the rear seat subportion remains in hingeable communication with a rear edge of the front seat subportion, slope adjustment of the rear subportion is accomplished through manipulation of the rear seat adjustment means 902, as was the case for the embodiment shown in FIG. 11A. Movement of adjustment means 904 results in tilting of the rear seat such that the distal edge of the rear seat resides below the plane defined by the front seat subportion.

FIG. 12B, shows an alternative configuration of the apparatus 100 wherein the adjustment means 904 is extended such that substantially all of the user contact surface 910 of the rear subportion 110 of the seat is substantially co-planar with the front subportion 112 of the seat. In another configuration, not shown, the rear subportion 110 is tilted so that the distal edge 913 of the rear subportion surface is above the plane formed by the user-contact surface of the first subportion 112. This configuration is in some ways the opposite of the configuration shown in FIG. 12A, inasmuch as the distal end is above the plane formed by the user-contact surface of the seat, while in FIG. 12A, the distal end is below the plane formed by the user-contact surface.

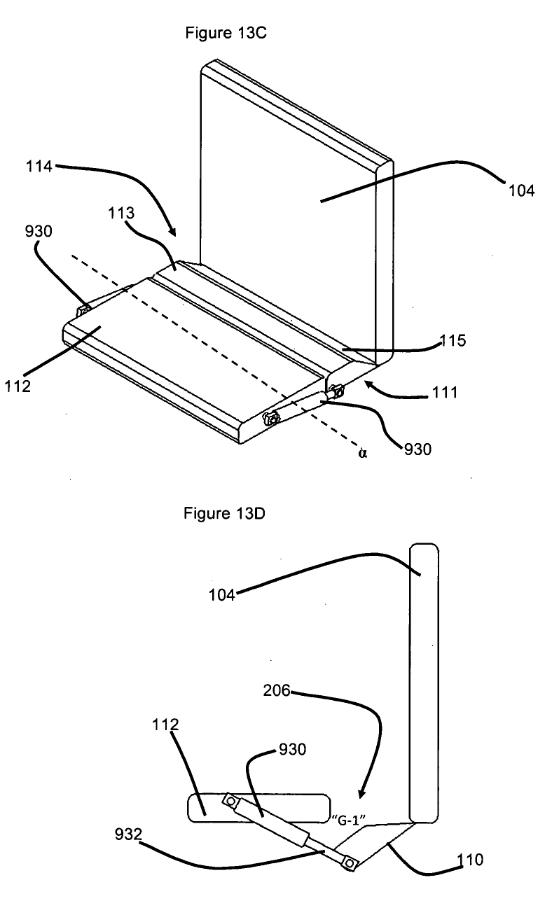

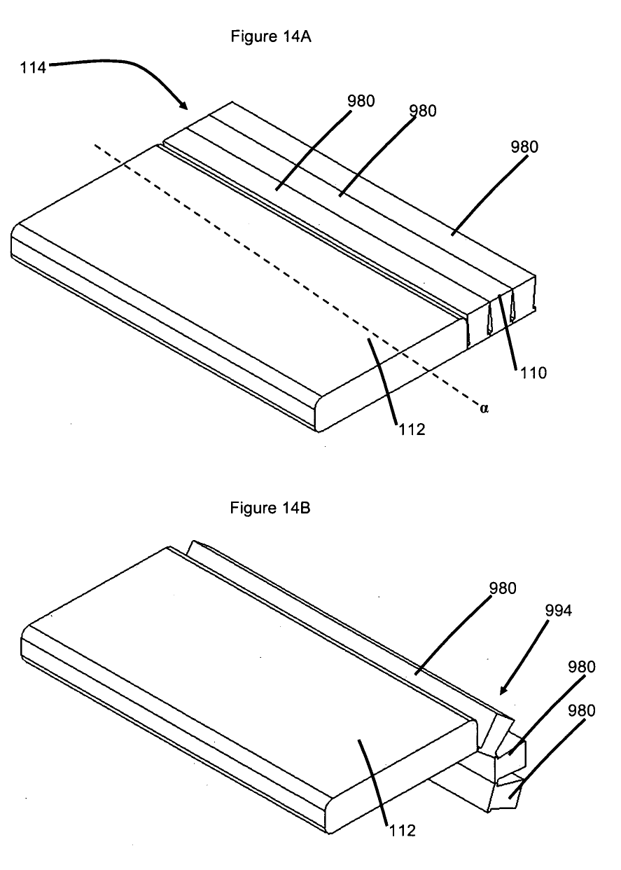

FIGS. 13A and 13B depict an alternative embodiment of the apparatus wherein the rear seat subportion changes from an initial position 114 to a rearwardly tilted position 206. FIG. 13A shows the apparatus seat assembly in the initial position, 114, wherein the front seat subportion 112 is essentially co-planar with the rear seat subportion 110. Pistons 930 are mounted on each side of the backrest 104 and the rear subportion 110 of the seat. The sides of the seat portions that contain the piston mounts are those sides which define surfaces extending perpendicularly to the longitudinal axis a of the surfaces formed by the seat portions. FIG. 13B shows a side view of the apparatus wherein the rear subportion of the seat 110 is in a tilted position 206 such that the distal edge 913 of the rear seat subportion slopes down and away from the plane defined by the front seat subportion. Alternatively, the rear seat portion is positioned so as to slope upwardly but still away from the seat plane.

Concomitant with the tilting actions of the rear seat subportion; the position of seat backrest 104 location remains constant (relative to the user-contact plane p it intersects). This is because in the tilted position 206 the pneumatic springs within pistons 930 result in telescopic extension of rear seat subportion lowering arms 932. The pneumatic spring within pistons 930 is triggered by a switch, on the piston, not shown. Retracting of the rear seat subportion lowering arms is facilitated by the similar release of the pneumatic spring within piston 930.

Position adjustment is accomplished through operation of mechanical stops positioned along the elongated longitudinal surfaces of telescoping rear seat subportion arms 932. In one embodiment, the stops comprise notches located at regular intervals on the subportion arms 932. The notches matingly interact with a ball detent mechanism 933 which is embedded or otherwise mounted in the wall of the first main piston. In an embodiment of the invention, the ball detent 933 is mounted to extend perpendicularly to the direction the first piston extends.

Another means for adjusting the extension of the first piston is via a friction ring arrangement whereby a constrictive ring is threadingly mounted to the cylinder of the first piston so as to frictionally engage the piston 932. The degree of tilting of the rear seat subportion is adjusted by moving the notches found on the telescoping arm 932, so that a notch is selected opposite the longitudinal axis situated on the second piston matingly receiving the second piston. Release of the rear seat subportion is accomplished by triggering a switch on the piston or by application of force to the rear seat subportion surface.

Alternatively, instead of a piston/cylinder configuration connecting the rear seat portion to the backrest portion, a rigid substrate, such as a rod pivotally mounts the rear seat portion to the backrest portion. In this embodiment, sloping the distal edge 913 of the rear seat portion either up or down results in the backrest advancing forward of or rearward of the user-contact plane p it intersects.

FIGS. 13C and 13D show another embodiment of the apparatus designed to change the tilt angle of the rear seat subportion 110. In the initial position 114 shown by FIG. 13C, a forward region 113 of a multiplanar rear subportion 111 is relatively co-planar with the front seat subportion 112. Pistons 930 are mounted on the side of the rear seat subportion 110 and the front seat subportion 112 in a similar manner as detailed above. In this configuration, the backrest 104 is in close proximity to the distal end of the rear subportion 110, but not attached to the rear subportion 110. As shown in the side view of FIG. 13D, the rear seat subportion 110 is placed in a tilted position 206 by the extension of rear seat subportion lowering arms 932 from within the piston body 930. During tilting of the rear seat subportion 110, the piston 930 remains attached to the front seat subportion 112. It is noteworthy that in this subtended configuration, the seat defines a gap “G-1” which affords users a means for contactless support of the tissue in close spatial relationship to the ischial region. A rearward region 115 of the multiplanar rear subportion 111, integrally molded with the forward region 113, is contoured to present a flat, substantially horizontal surface, where the gap G-1 is formed. This horizontal surface, positioned at the reward portion of the seat area confers a flat-bottomed depression to accommodate users experiencing heightened pain (i.e. coccydynia) to the tailbone or coccyx region of the spine.

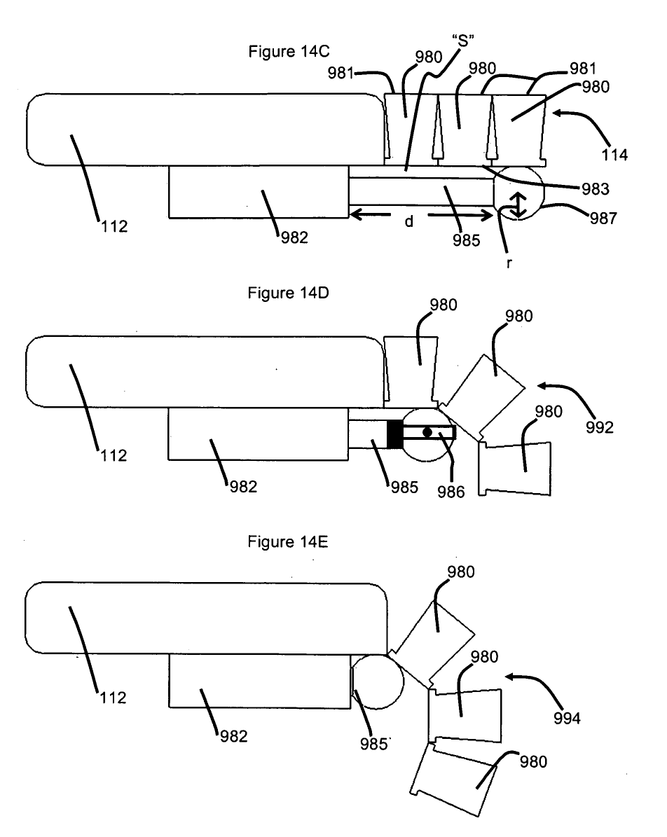

Turning now to FIGS. 14A to 14E, depicted therein is an alternate embodiment of the invention wherein the rear seat subportion 110 is further divided into multiple segments 980 so as to vary pressure to a user's coccyx and ischial region. Depicted in FIG. 14A, which is a perspective view of the seat assembly, are three segments 980, defining user-contact surfaces extending in a direction parallel to the longitudinal axis a of the device. In other embodiments, a plurality of segments (i.e. n-segments) is used where n is an integer from 2 to 10. The choice of n is dependent upon several factors such as the relative size of the user-contact surface of the rear seat subportion 110 as compared with the front seat subportion 112. The larger the relative size of the surface of the rear seat subportion 110, the larger the number n becomes. As shown in FIG. 14A, in the initial seat position 114, the rear seat subportion segments 980 are essentially co-planar with the front seat subportion 112. In another configuration, as shown in FIG. 14B, when the rear seat subportion segments 980 cascade from a vertical to a horizontal position, the rear seat subportion 110 provides selective user support, by, in one instance, shifting the weight of the user to the front subportion 112 of the seat.

FIGS. 14C to 14E are side views of the seat assembly at three positions of the rear seat subportion segments. First, FIG. 14C shows a side view of the front subportion 112 and three segments 980 at initial upright or vertical position 114 during which the upwardly facing surfaces 981 of the segments 980 are essentially coplanar with the front subportion 112. The three segments 980 are supported by a telescoping rear seat subportion segment support arm 985 positioned underneath the plane formed by the front subportion user contact surface and extending horizontally toward the rear of the apparatus. The telescoping rear seat subportion segment support arm 985 extends from a sleeve 982 and in a direction generally perpendicular to the longitudinal axis a of the device. At the initial position 114, the telescoping rear seat subportion segment support arm 985 extends fully a distance d so as to support each of the segments 980. The arm terminates in a sphere 987.

Second, as depicted in FIG. 14D, in an intermediate position 992, the telescoping rear seat subportion segment support arm 985 is extended partially away from the front of the apparatus so as to render support only to some of the segments 980. At the intermediate position 992, any unsupported segments 980 drop below the plane formed by the supported segments 980 and the front seat subportion 112.

Third, the final position 994 is shown in the side view of the invention in FIG. 14E. In the final position 994, the telescoping rear seat subportion segment support arm 985 is essentially retracted into a sleeve 982. The lack of support for the rear seat subportion segments 980 results in gravity pulling these unsupported segments 980 down so as to result in the supports forming a downward slope extending away from the front seat portion so as to hang off the rear of the apparatus. In position 994, the rear seat subportion provides the least amount of support to the coccyx and ischial region of the user of the chair, therefore providing a means for eliminating contact-pressure to the coccyx and ischial region.

A space “S” exists between downward facing surfaces 983 of the segments 980 and the telescoping rod 985. This space “S” provides a means for moving the rod 985 which in turn provides support for the segments 980 when pressure is applied to the upwardly facing surface 981 of the segments 980. The “S” space exists as the radius “r” of the sphere 987 exceeds the outer diameter of the cross section of the arm 985. The sphere 987 comprises a ball in rotatable communication with the rod 985, whereby the ball is nested in a retainer ring 986 rigidly attached to the rod. The sphere, while retained in the ring, is further in rotatable communication with the downward facing surface 983 of the segments as the rod is deployed along a distance d, as depicted in FIG. 14D. This way, the rolling of the ball facilitates low friction interaction between the ball and the surface 983 as the rod 985 is deployed outwardly.

While only one telescoping support arm 985 is shown in FIGS. 14C to 14E, it should be appreciated that depending on the desired size and/or support requirements of the chair, multiple telescoping support arms 985 may be desired. In instances where multiple telescoping support arms 985 are used, the adjustment mechanism changes the position of the multiple telescoping support arms 985 concurrently. It should be appreciated that any known mechanism can be employed to move the telescoping arm 985 back and forth, including a pneumatic spring and piston, and/or a crank and gear mechanism.

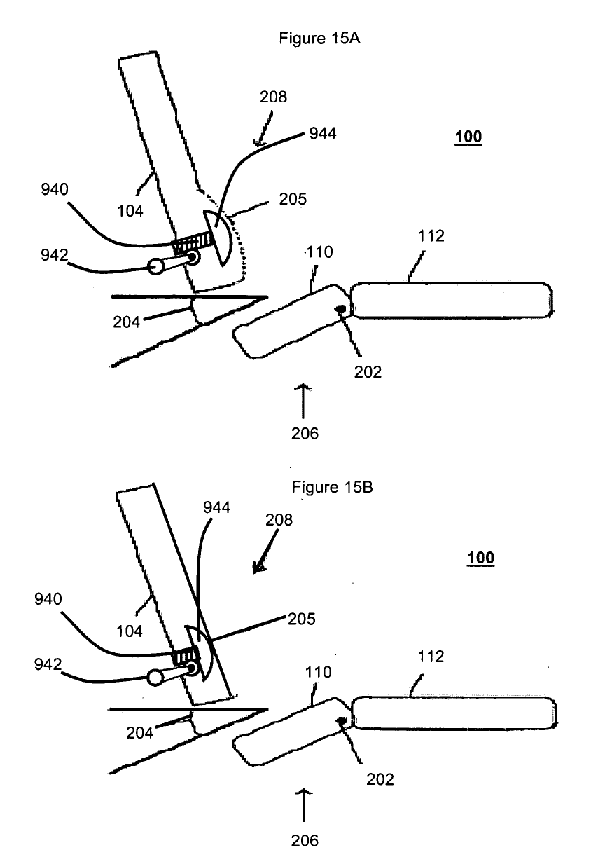

FIGS. 11A to 14E demonstrate alternative embodiments of the apparatus providing for the adjustment of the vertical position of the seat rear subportion 110 so as to shift the balance of weight of the user of the apparatus. Referring now to FIG. 15A-B, disclosed therein is yet another embodiment of the invention. In FIG. 15A, the apparatus 100 comprises a seat having a rear subportion 110, a front subportion 112, and a backrest 104. The backrest 104, comprises a lumbar contact substrate 944, substrate movement means 940 and positioning means 942. As shown in FIG. 15A, the movement means 940 is extended so that the lumbar contact substrate 944 creates a convex topography to that region of the backrest 104. FIG. 15B shows an alternative configuration of the embodiment of the invention from FIG. 15A. In the FIG. 15B configuration, the substrate movement means 940 is retracted and the backrest 104 is relatively flat. Whilst in this configuration, the lumbar contact substrate 944 is entirely encompassed by the backrest 104.

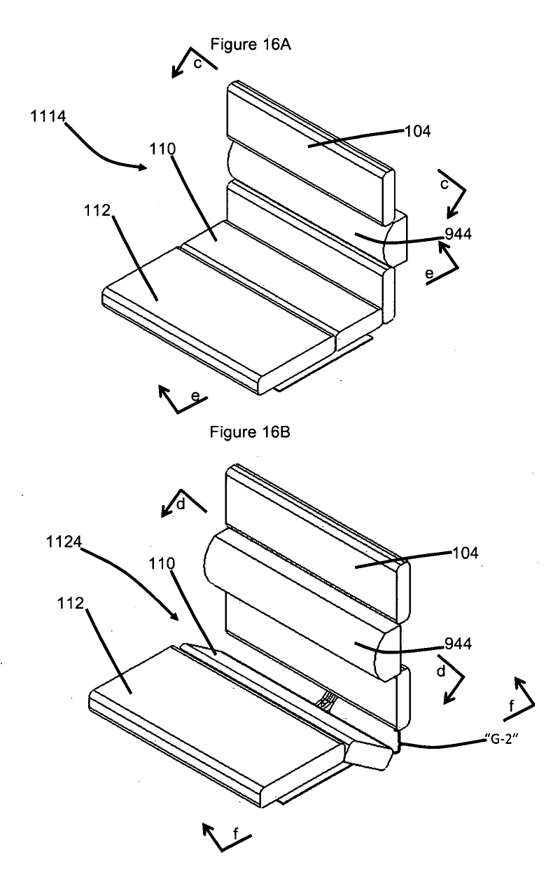

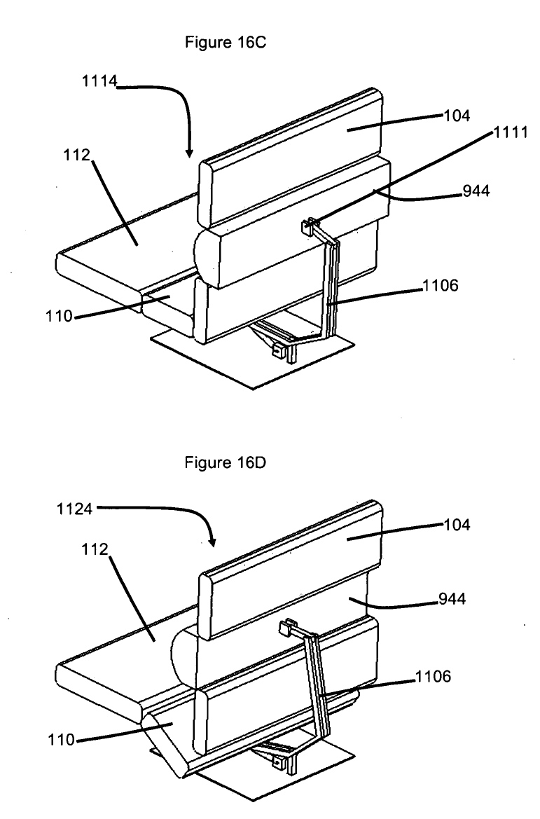

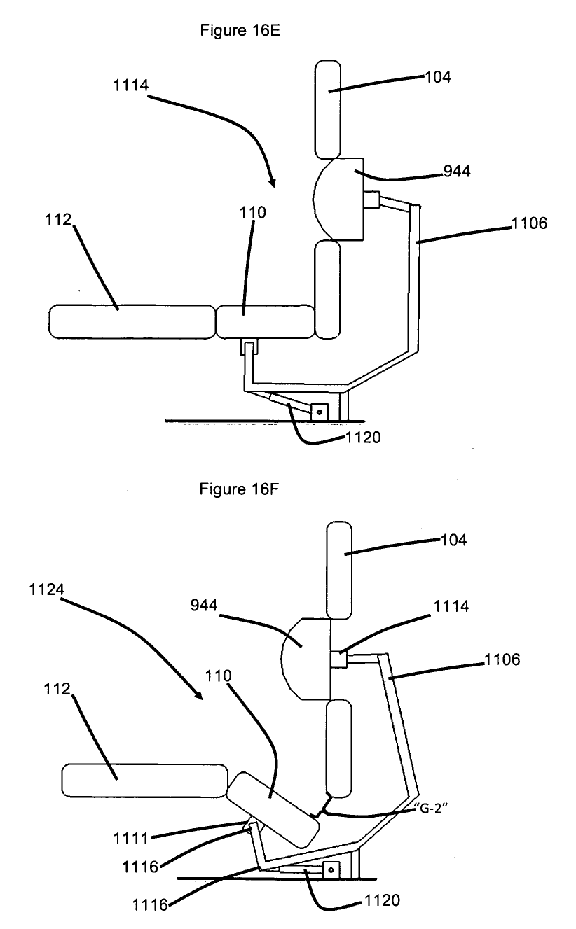

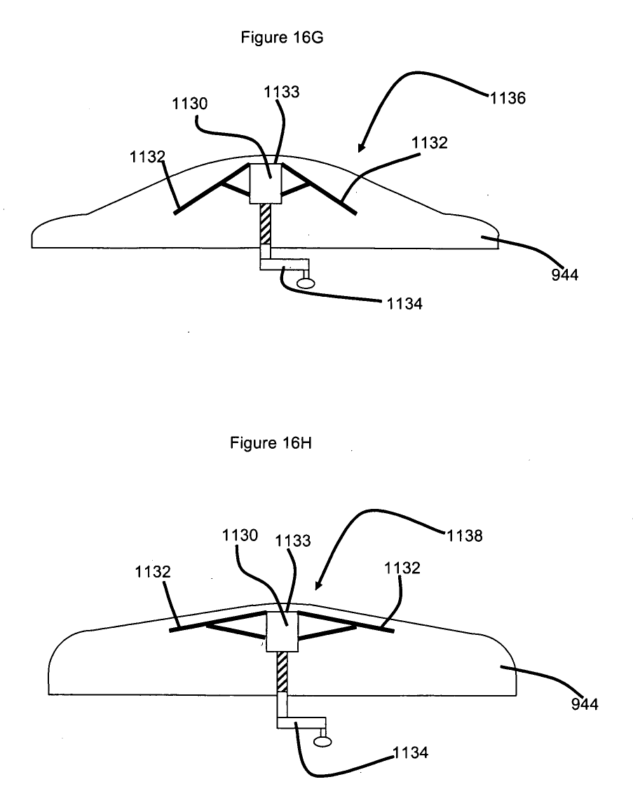

Another embodiment of the invention is disclosed by FIGS. 16A to 16H. FIG. 16A depicts an apparatus comprising a backrest 104, a seat rear subportion 110, a seat front subportion 112, and a lumbar contact substrate 944. In a preferred embodiment (not shown) the lumbar contact substrate 944 comprises horizontal edges that are tapered. In this embodiment, the lumbar contact substrate 944 is substantially flat at a first horizontal edge gradually increasing slope thereby forming a substantially parabolic shape that is shown in FIGS. 16A to 16F at an apex point in or about the middle of the lumbar contact substrate. The slope of the lumbar contact substrate decreases past the apex point reaching a substantially flat profile at a second horizontal edge. In some embodiments, the apex is a relatively small area, comprising no more than 10% of the total surface area of the lumbar contact substrate 944. In other embodiments, the apex is a substantial portion of the total surface area of the lumbar contact substrate 944, such as requiring 90% of the total surface area of the lumbar contact substrate 944. In such an embodiment, the apex forms a plateau on the lumbar contact substrate 944. In yet another alternative embodiment, the shape of the lumbar contact substrate 944 apex can be manipulated, bringing it from a first configuration to a second configuration, wherein the surface area of the apex ranges from 10% to 90% of the surface area of the lumbar contact substrate 944.

An adjustment mechanism for changing the shape of the lumbar contact substrate 944 is the subject of FIGS. 16G and 16H. The lumbar contact substrate 944 forms a part of the backrest 104 as shown in other figures. In the embodiment shown in FIGS. 16G and 16H, the lumbar contact substrate 944 includes a shape adjustment means 1130.

The shape adjustment means 1130 comprises a first point of contact 1133 of the shape adjustment means with a first interior surface of the backrest 104, and second points of contact 1132 of the shape adjustment means with a second interior surface of the backrest 104. The second points of contact 1132 are in hingeable communication with first point of contact 1133. Both points of contact are operated through the manipulation of a shape selection means 1134, such as a hand crank assembly shown in FIGS. 16G and 16H. The shape adjustment means 1130, while in a first configuration 1136 shown in FIG. 16G, can be activated through operation of shape selection means 1134, so as to change the shape of the lumbar contact substrate 944 to conform to a second configuration 1138 shown in FIG. 16H. In the deployed configuration 1138, both points of contact apply maximum outward pressure to their respective opposing portions of the interior surface of the backrest 104.

Additionally, while FIGS. 16G and 16H depict two distinct configurations, it should be appreciated that intermediate configurations may be reached through partial manipulation of the shape selection means 1134.

In an alternative embodiment, also not shown, the lumbar contact substrate 944 is integral to the backrest 104. As shown in FIG. 16A, whilst the apparatus is in position 1114, the lumbar contact substrate 944 is essentially coplanar with the backrest 104. At position 1114, the rear subportion 110 of the seat is coplanar with the front subportion of the seat 112.

FIG. 16B shows the apparatus in the alternative position 1124. When the apparatus is configured to position 1124, the rear seat subportion 110 is in an open position. Further, in position 1124, lumbar contact substrate 944 creates an indentation in the backrest 104. As shown in FIGS. 16A and 16B the user contact points with the apparatus are distinct when the apparatus is in position 1114 and the alternative position 1124.

It should be further appreciated that different positions, not depicted, are possible. For example, the opening of the rear subportion 110 could only be partial. Additionally, in some embodiments the lumbar contact substrate 944 and the rear seat subportion 110 act in concert, other embodiments exist wherein each is operated independently.

Each position, such as position 1114 in FIG. 16A or position 1124 in FIG. 16B, is associated with different benefits for the apparatus user. Specifically, as is the case in position 1124, the extended lumbar support substrate forces the user's lumbar spine into a lordotic curve, which opens the user's intervertebral space. With the user's spine in this position, the intervertebral disc in lumbar region will bear less load. As such, the seat configuration resulting in a rearward gap G-2 provides a measure for imparting a beneficial curvature of the spine of a user. Further, with the lumbar support extended, the user's lumbar muscles are less stressed. The second feature of position 1124 is that the seat rear subportion 110 is opened and pivoted away from the user. When combined with extension of the lumbar support, the opening of the seat rear subportion causes the user's pelvis to rotate freely, which releases the stress of the back muscles in lumbar region. Position 1124 is beneficial for users suffering from pain in the lower back. However, it benefits all users inasmuch as it prevents the onset of pain for those users who do not currently suffer from it. As such, the apparatus is adjustable between position 1124 and other positions, such as position 1114.

Turning now to FIG. 16C, depicted therein is a perspective view of the alternative embodiment shown in FIGS. 16A and 16B, detailing the rear portions of the apparatus. FIG. 16C depicts the apparatus in position 1114. In position 1114 the rear seat subportion and lumbar support substrate adjustment mechanism 1106 is configured to position 1114 setting wherein the rear seat subportion 110 is essentially horizontally co-planar with the front subportion 112 and the lumbar impact substrate 944 is essentially vertically co-planar with the backrest 104.

Apparatus position 1124 is depicted in FIG. 16D. Shown therein is the rear seat subportion and lumbar support substrate adjustment mechanism 1106 configured so that the apparatus is in position 1124. The rear seat subportion and lumbar support substrate adjustment mechanism 1106 has tilted the rear seat subportion 110. Further, in position 1124, the lumbar impact substrate 944 extends beyond the vertical plane formed by the backrest 104 through the pushing action of the rear seat subportion and lumbar support substrate adjustment mechanism 1106. Shown in FIGS. 16E and 16F are side views of the embodiment depicted in FIG. 16A to 16D. FIG. 16E shows the lumbar contact substrate 944 and the rear seat subportion 110 configured in apparatus position 1114. FIG. 16F shows the configuration of the lumbar contact substrate 944 and the rear seat subportion 110 in apparatus position 1124. The transition from position 1114 of FIG. 16E to position 1124 of FIG. 16F is accomplished by manipulation of the rear seat subportion and a lumbar support adjustment arm 1106. The adjustment arm 1106 is roughly “C’ shaped so as to be attached at its lower leg to the rear seat subportion joint 1111 and at its upper leg to a hinge or ball-bearing joint 1114 which is attached to a rearward facing surface of the lumbar contact substrate 944. The ends of the upper and lower arms of the arm 1106 terminate in means for pivotally connecting the arm to a rearward-facing portion of the seat back 944 and a downwardly-facing portion of the seat 112. Exemplary means include two hinges or ball-bearing joints.

In one embodiment of the invention, the adjustment arm 1106 comprises a single piece. In other embodiments, hinges or ball-bearings of arm 1116 are included within the support arm. In either embodiment, the adjustment arm 1106 is connected to a piston 1120, and this piston 1120 actually facilitates the movement of the adjustment arm 1106, which is translated into movement of the lumbar substrate 944 and rear seat subportion 110. Upon extension of the piston 1120, the apparatus is placed in position 1114, as depicted in FIG. 16E. At instances where the piston 1120 is retracted, the adjustment arm 1106 pulls down on the rear seat subportion 110 and pushes the lumbar contact substrate 944 forward, and the apparatus is placed in position 1124.

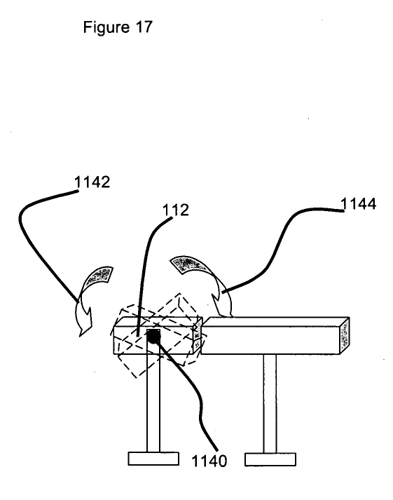

Some embodiments of the invention include a tilting function, as depicted in FIG. 17. These embodiments include a tilting member 1140, which facilitates pivotal movement of the rear subportion of the apparatus. Operation of the tilting member 1140 moves the seat subportion to several alternative configurations. The configurations can include lateral movement, such as movement to the right, 1142, and movement to the left, 1144, but can also result in vertical movement (not shown), or a combination of both. It should be understood that the pivotal movement of the seat subportion may be an additional feature of any embodiment of the apparatus discussed herein.

In some alternative embodiments, areas of the apparatus, such as the backrest 104 or the seat subportion 110, may include one or more data input components. The input components relay information regarding the position of the user of the apparatus to a CPU which may or may not be remotely situated from the user. Inasmuch as, in the alternative embodiment, the adjustment means 902 is manually-operated, the data from the input components is relayed so that a manual adjustment may be accomplished. In yet another alternative design, the adjustment means 902 is subject to additional powered adjustment means and is automated in response to readings from the apparatus input components. The data gathered from the input components is retained in a data cache in electrical communication with the CPU, and can be used to evaluate the number of changes to the position of apparatus user, and the frequency of the changes. As such, the gathering of the input component metrics from the apparatus may be used to monitor quality of care services delivered to the end-user of the apparatus.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

While the invention has been described in the foregoing with references to details of the illustrated embodiments, those details are not intended to limit the scope for the invention as defined in the appended claims.

The embodiment of the invention in which an exclusive property or privilege is claimed is defined as follows:

1. An apparatus, comprising:
a) a seat that comprises a front subportion and a rear subportion wherein the rear subportion is supported by an one or more adjustable supports;
b) a means for adjusting a rear subportion;
c) a backrest;
d) a lumbar contact substrate; and
e) a means for adjusting position of the lumbar contact substrate;
wherein, manipulation of the rear subportion adjustment means changes the position of the rear subportion of the seat from a first height and/or angle of the rear subportion of the seat to a second height and/or angle of the rear subportion of the seat; and wherein, manipulation of the backrest shape adjustment means changes the shape of the backrest from a first shape of the backrest to a second shape of the backrest, and manipulation of the lumbar contact substrate adjustment means changes the position of the lumbar contact substrate.

2. The apparatus as recited in claim 1 wherein the rear subportion comprises multiplanar surfaces.

3. The apparatus as recited in claim 2 wherein the multiplanar surfaces are integrally molded to each other.

4. The apparatus as recited in claim 2 wherein the multiplanar surfaces adjust independent of each other.

5. The apparatus as recited in claim 3 wherein the rear subportion is adapted to simultaneously tilt downwardly and provide a horizontal flat surface.

6. The apparatus of claim 1 wherein the backrest shape adjustment means further defines a lumbar area which alternates from a convex to a flat topography.

7. The apparatus as recited in claim 4 further comprising a telescoping substrate adapted to extend underneath the multiplanar surfaces so as to define a span between the surfaces and the substrate.

8. The apparatus of claim 4, wherein the lumbar contact substrate adjustment means move the lumbar contact substrate from a first position where the lumbar contact substrate is substantially coplanar with the backrest to a second position where the lumbar contact substrate extends into a plane formed by the backrest.

9. The apparatus of claim 1, wherein the first height and/or angle of the rear subportion of the seat and a corresponding height and/or angle of the front subportion of the seat comprise a substantially same height and/or angle; wherein the second height and/or angle of the rear subportion of the seat is/are less than the corresponding height and/or angle of the front subportion of the seat.

10. The apparatus of claim 9, further comprising one or more input sensors located within the front portion of the seat, and/or the rear portion of the seat, and/or the backrest, and input sensor reading transmittal means wherein the input sensors reflect user pressure.

11. The apparatus of claim 10, wherein readings from the input sensors are transmitted by the transmittal means to a central data-collection point.

12. The apparatus of claim 11 wherein manipulation of the rear subportion adjustment means is performed by an operator once a data threshold is reached within the central data-collection point.

13. The apparatus of claim 12 wherein the data threshold is calculated based on the amount of time an apparatus user has remained in a first position.

14. An apparatus, comprising:
a seat that comprises a front subportion and a rear subportion that is supported by an one or more adjustable supports;
a lumbar contact substrate;
a backrest;
an adjustment mechanism in communication with the rear seat subportion and the lumbar contact substrate; and
wherein, manipulation of the adjustment mechanism changes the position of the rear seat subportion from a first position to a second position and the lumbar contact substrate changes shape from a first shape to a second shape.

15. The apparatus of claim 14 wherein the adjustment mechanism is selectable as to whether it will affect the rear seat subportion or the lumbar contact substrate, or both.

16. The apparatus of claim 15 wherein the adjustment of the position of the rear seat subportion occurs simultaneously with the change of the shape of the lumbar contact substrate.

17. The apparatus of claim 14 wherein one end of the rear seat subportion adjustable supports is mounted on the rear seat subportion and the opposing end is mounted on the backrest.

18. The apparatus of claim 14 wherein one end of the rear seat subportion adjustable supports is mounted on the rear seat subportion and the opposing end is mounted on the front seat subportion.

19. A method, comprising the steps of:
adjusting a lumbar region of a backrest between a first shape and a second shape based on manipulation of a manual adjustment means; and
adjusting a rear subportion of a seat between a first height and/or angle and a second height and/or angle relative to a front subportion of the seat based on manipulation of a manual adjustment means.

20. The method of claim 19, further comprising simultaneous adjustment of the lumbar region of a backrest from a first shape to a second shape and adjustment of the rear subportion from the first height and/or angle to the second height and/or angle.
